(19) United States
(12) Patent Application Publication
(10) Pub. No.: US 2018/0165779 A1
(43) Pub. Date: Jun. 14, 2018

(54) SYSTEM AND METHOD FOR EVENT MANAGEMENT IN AN ONLINE VIRTUAL LEARNING ENVIRONMENT WITH INTEGRATED REAL-LEARNING AUGMENTATION AND CYBER WORKFORCE OPTIMIZATION

(71) Applicant: Scriyb LLC, Manassas, VA (US)

(72) Inventors: Scott McKay Martin, Fairfax Station, VA (US); James R. Casey, II, Fairfax, VA (US); Christopher Etesse, Paeonian Springs, VA (US); John Damici, Vienna, VA (US)

(73) Assignee: Scriyb LLC, Manassas, VA (US)

(21) Appl. No.: 15/813,922

(22) Filed: Nov. 15, 2017

Related U.S. Application Data
(60) Provisional application No. 62/422,557, filed on Nov. 15, 2016.

(51) Int. Cl. G06Q 50/20; G06Q 10/06; G09B 5/06; G09B 5/12; G09B 7/00

(52) U.S. Cl. CPC G06Q 50/2057; G06Q 10/063112; G06Q 10/06398; G09B 19/0053; G09B 5/065; G09B 5/12; G09B 7/00; G06Q 10/063118

(57) ABSTRACT

A system and method provide continuous workforce optimization based on observations of users in an online learning management system integrated with physical learning nodes that can be interconnected with other physical learning nodes for multi-site workforce optimizations. The system provides online group learning courses to users via a network. The system may integrate with conventional physical classrooms, which may be physically located at different institutions, allowing for cross-site (e.g., cross-university, cross-military unit, cross-corporation, etc.) collaborative learning. The system may monitor user interactions during the online group learning courses and generate user profiles based on the user interactions. For example, for students (e.g., military personnel) training in cyber warfare using the online group learning courses, the system may track their performance via the monitored interactions, and place them into workforces to address cyber warfare needs.

### CROSS-REFERENCE TO RELATED APPLICATION

The invention claims the benefit of priority to U.S. Provisional App. No. 62/422,557, entitled SYSTEM AND METHOD FOR EVENT MANAGEMENT IN AN ONLINE VIRTUAL LEARNING ENVIRONMENT WITH INTEGRATED REAL-LEARNING AUGMENTATION AND CYBER WORKFORCE OPTIMIZATION, Martin et al., filed Nov. 15, 2016, which is incorporated by reference herein in its entirety.

### FIELD OF THE INVENTION

The invention relates to a system and method for continuous workforce optimization based on observations of workforce users in an online learning management system integrated with physical learning nodes that can be interconnected with other physical learning nodes for multi-site workforce optimizations.

### BACKGROUND OF THE INVENTION

Conventional university and training programs are typically more concerned with strategic initiatives than with leveraging technology to achieve good outcomes. For example, during educational instruction, large amounts of data is generated but unused by conventional learning environments, both physical (i.e., in-classroom) and electronic (e.g., online educational systems) to assess student achievement and success (as well as non-achievement and failure). For example, student and teacher interactions during class, the type of interactions, quality of interactions, and social media usage, in combination with traditional metrics of achievement such as test scores, are typically not used to assess students, even though the foregoing information may provide valuable insights.

Although conventional electronic learning systems attempt to make learning easier and more convenient, they are oftentimes seen by students and teachers to be burdens with a perception that they do not provide high value with respect to employers and others. Nonetheless, students continue to enroll in conventional electronic learning systems.

These and other drawbacks exist with conventional online learning systems.

### SUMMARY OF THE INVENTION

The invention addressing these and other drawbacks relates to systems and methods for continuous workforce optimization based on observations of workforce users in an online learning management system integrated with physical learning nodes that can be interconnected with other physical learning nodes for multi-site workforce optimizations, according to an implementation of the invention. Physical learning nodes may be off-site or external system or systems that are network connected and part of a clustered or grouped learning team within a larger learning multi-site schemata.

In some implementations, for example, the system may facilitate electronic group learning by providing one or more electronic tools for students (e.g., users that use the system to obtain knowledge or otherwise receive training) and teachers (e.g., users that use the system to provide knowledge or otherwise train other users) to interact with one another and with course content.

In some implementations, the system may conduct online group learning courses that are integrated with physical learning courses at a physical learning node. A physical learning course may include conventional classrooms in which students learn from instructor in person. Such integration permits augmentation of traditional classrooms with electronic group learning, collaboration between different instructors or physical learning nodes, and/or other benefits as will be apparent based on the disclosure herein.

System integration with traditional classrooms (whether at a university, military facility, corporate campus, etc.) may permit an instructor to provide enhanced teaching to a classroom. For example, in a traditional classroom, students may logon using their own client device or a university-provided client device (e.g., that is part of a classroom). Such logon may use the university's computer network (or in other implementations the user's Internet access). Use of the university's computer network may result in automatic authentication of the user, provided that the university's computer network has been registered with the system, and provided that the user's client device is already known to the system to be associated with the user. The system may provide electronic tools for the instructor and students to interact with one another within a traditional classroom. Furthermore, the instructor may remotely conduct certain courses, or authorize guest speaker/lecturers to remotely logon to give a portion or all of a given course session. Still further, a given student may remotely logon to attend a traditional classroom, which may be live-streamed via the system.

System integration with traditional classrooms (whether at a university, military facility, corporate campus, etc.) may permit collaboration among different physical learning nodes. For example, and without limitation, a professor from a first university may be a registered instructor for an online group learning course taken by students from the first university and also students from one or more other universities. Students from the other universities may still attend traditional physical classrooms to participate in the online group learning course, which is taught from the professor from the first university via the system. Alternatively or additionally, students from the first university and/or the other universities may remotely logon (e.g., outside of their university's computer network and not while in a traditional physical classroom) to the system. In some instances, two or more instructors may co-teach a group learning course via the system, while students may be at physical classrooms to logon and/or may logon remotely.

In another example, one or more users from a first military facility (and/or other military facilities) may provide cyber training to users at the first military facility and/or at other military facilities. Users at the first military facility and/or at other military facilities may logon from their respective facilities and/or remotely to participate in the cyber training.

The system may group students into one or more groups based on information known about each student. During a course session, the system may monitor user interactions made via the electronic tools, and dynamically regroup the students based on the monitored user interactions.

In some implementations, the system may generate and/or update user profiles of users based on the monitored user interactions. Each user profile may include, among other information, competency scores of a user. A competency score may reflect a level or knowledge, ability or achievement with respect to a category of information or skill. For example, a competency score for communication skills may reflect a communication ability of a user. A competency score for a particular subject matter may reflect a user's knowledge of that subject matter. The user profile may include information known about the user other than competency scores. For instance, the user profile may include an information indicating an education level, professional certifications, and/or other information known about the user that is not a competency score.

The user profile may be used in various ways, such as for the aforementioned grouping/regrouping, but also for workforce assignments. For example, the system may assign users (whether students or teachers) to a workforce to complete or otherwise resolve a task. A workforce may be comprised of one or more users selected to complete the task.

To generate a task, the system may obtain event information that describes various events. Such events may be automatically (e.g., by the system without human intervention) detected via event listeners. Examples of automatically detected events include, without limitation, suspected network intrusion events (e.g., a number of failed logon attempts), suspected malicious request events (e.g., a number of requests within an time interval that exceeds an expected number, which may indicate a potential denial of service style attack), and/or other types of automatically detected events. Although the foregoing and other examples throughout this disclosure may refer to cyber related events and tasks, other types of events and tasks for which workforces may be assigned may be used.

The system may generate a task based on the obtained events. For example, the system may correlate detected events into an actionable item that should be resolved via a task. The system may automatically associate the task with one or more task parameters. A task parameter may describe what is needed to resolve the task. For example, a task related to network intrusion mitigation may require knowledge relating to network authentication systems and an ability to conference with other users to confirm and mitigate a problem. As such, the task may be associated with task parameters that require the foregoing skills. In some instances, a task may be manually input by a user, such as to create a training task, create a cyber objective to be accomplished, and/or achieve some other objective. In these instances, the user may input task parameters relating to the task.

Whether a task is manually or automatically generated, the system may identify a workforce to handle the task. The system may do so by matching task parameters of the task with user profile information such as competency scores to identify a workforce. In some respects, the workforce may be generated in a manner similar to the way in which students are grouped for group learning.

In some implementations, the system may match the task with users based on machine learning models that model outcomes of tasks based on user profiles of users assigned to handle the tasks. For example, a machine learning model may output a predicted outcome score based on task parameter inputs and competency score (and/or other user profile information) inputs. The model may be based on empirical information, training information, and/or other information than can inform the model of potential outcomes. In this sense, a workforce may be “optimal” based on having the highest predicted outcome score.

In some implementations, the system may match the task with users based on one or more rules. For example, a rule may specify that a network intrusion task associated with a first number (or range of number) of intrusion events should be handled by users who have at least a first competency score with respect to authentication systems, while a network intrusion task associated with a second number (or range of number) of intrusion events should be handled by users who have at least a second competency score with respect to authentication systems. In this sense, the term “optimal” may refer to the best outcome (e.g., most closely matching the rule) given the pool of users available to be assigned to a workforce.

Once a workforce is assigned to a task, the system may monitor performance of the task (and other ongoing tasks). Based on the monitoring, evolving task, conditions, availability of users that can be assigned to a given workforce, and other factors, the system may rebalance the workforce. In other words, the system may add a user to, remove a user from, replace one user with another user, or otherwise modify the workforce to address any changing needs of the task and/or changing environment. Further based on the monitoring, each user profile may be updated based on user performance of the task. As such, a user who is underperforming at a given task may be rebalanced to participate in another task (or no task at all).

In one embodiment, the present invention provides a system of identifying and rebalancing a workforce of users from within a pool of users for resolution of a task based on user attributes that indicate user competencies, skills, and abilities. The system comprises a computer system comprising one or more physical processors programmed by computer program instructions that, when executed, cause the computer system to: obtain event information comprising an indication of events; generate a task based on the event information, wherein the task is associated with at least a first task parameter that specifies a requirement of the task; obtain a plurality of user profiles comprising at least a first user profile of a first user, the first user profile comprising a set of first user attributes, the set of first user attributes comprising a first competency score of the first user, wherein the first competency score reflects a level of skill or knowledge of the first user; and generate, at a first time, a workforce comprising a set of users and including the first user, based on the first task parameter and the set of first user attributes.

The system of the above embodiment may be further caused to: generate and provide one or more electronic tools for the first user to participate in an online group learning course; monitor one or more user interactions, relevant to the first user, associated with the online group learning course; generate the first competency score of the first user based on the one or more user interactions; and add the first competency score to the first user profile. The system may be further caused to: determine, at a second time after the first time, that the task has changed; and rebalance, at the second time, the set of users assigned to the workforce based on one or both of: 1) a determination that the task has changed; and 2) a determination of a change to one or more user competency scores assigned to or available to be assigned to the workforce. The rebalancing of the workforce may be caused by one or both of: 1) adding and/or removing one or more users to/from the workforce; and 2) altering task assignments of one or more users in the workforce. The determination that the first task has changed may be based on a determined change in the first task parameter that specifies the requirement of the task. The system may be further caused to: determine, at a second time after the first time, that the first competency score has changed; and rebalance, at the second time, the workforce based on the determination that the first competency score has changed. The determination that the first competency score has changed may be based on a determined change in the level of skill or knowledge of the first user. The system, in generating the task, may be further caused to correlate the events into an actionable item that is to be resolved by the task. The set of first user attributes may further comprise one or more of a performance score, a communication score, an academic achievement score, a social score, an education level, and a set of professional certifications.

In another embodiment, the present invention provides a system of identifying and rebalancing a workforce of users from within a pool of users for resolution of a task based on user attributes that indicate user competencies, skills, and abilities, the system comprising: a computer system comprising one or more physical processors programmed by computer program instructions stored in an associated memory for execution by the processors; a task detection engine configured to obtain event information comprising an indication of events, and generate a task based on the event information, wherein the task is associated with at least a first task parameter that specifies a requirement of the task; a task assignment engine configured to obtain a plurality of user profiles comprising at least a first user profile of a first user, the first user profile comprising a set of first user attributes, the set of first user attributes comprising a first competency score of the first user, wherein the first competency score reflects a level of skill or knowledge of the first user; wherein the task assignment engine is further configured to generate, at a first time, a workforce comprising a set of users including the first user, based on the first task parameter and the first user profile; and a dynamic regrouping engine configured to rebalance, at a second time after the first time, the workforce set of users based on one or both of: 1) a detected change in the first task parameter; and 2) a detected change to one or more user competency scores assigned to or available to be assigned to the workforce. The system may be further configured to: generate and provide one or more electronic tools for the first user to participate in an online group learning course; monitor one or more user interactions, relevant to the first user, associated with the online group learning course; generate the first competency score of the first user based on the one or more user interactions; and add the first competency score to the first user profile. The set of first user attributes may further comprise one or more of a performance score, a communication score, an academic achievement score, a social score, an education level, and a set of professional certifications.

In yet another embodiment, the present invention provides a system for integrating an online learning management system with physical learning nodes, the system comprising: a computer system comprising one or more physical processors programmed by computer program instructions that, when executed, cause the computer system to: obtain first content from an instructor; authenticate a first student associated with a first physical learning node and a second student associated with a second physical learning node; provide the first student and the second student with the course content; provide the instructor, the first student, and the second student each with respective electronic tools for interacting with the course content and/or each other; monitor user interactions via the respective electronic tools; and generate a set of user profiles each of which includes a set of user attributes including a set of competency scores associated with at least the first student and the second student. The set of user attributes may further comprise one or more of a performance score, a communication score, an academic achievement score, a social score, an education level, and a set of professional certifications.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system for optimizing workforces for tasks based on observations of workforce users in an online learning management system integrated with physical learning nodes that can be interconnected with other physical learning nodes for multi-site workforce optimizations, according to an implementation of the invention.

FIG. 2 illustrates a computer system for optimizing workforces for tasks based on observations of the users, according to an implementation of the invention.

FIG. 3 illustrates a client device that participates in an online learning management system, according to an implementation of the invention.

FIG. 4 illustrates a schematic diagram of data flows optimizing workforces for tasks based on observations of the users in an online learning management system integrated with physical learning nodes that can be interconnected with other physical learning nodes for multi-site workforce optimizations, according to an implementation of the invention.

FIG. 5 illustrates a schematic diagram for rebalancing a workforce, according to an implementation of the invention.

FIG. 6 illustrates a process of integrating an online learning management system with physical learning nodes that can be interconnected with other physical learning nodes, according to an implementation of the invention.

FIG. 7 illustrates a process of optimizing workforces for tasks based on observations of the users in an online learning management system integrated with physical learning nodes that can be interconnected with other physical learning nodes for multi-site workforce optimizations, according to an implementation of the invention.

### DETAILED DESCRIPTION OF THE INVENTION

The present invention provides a technical solution that addresses the above-described shortcomings as well as other drawbacks associated with prior systems. In accordance with one implementation of the invention, systems and methods are herein described for continuous workforce optimization based on observations of workforce users in an online learning management system integrated with physical learning nodes that can be interconnected with other physical learning nodes for multi-site workforce optimizations. A workforce may be made up of one or many users and may include any user described herein and who may participate in a task. A workforce user typically is associated with a user profile as described herein.

The system may facilitate electronic group learning by providing one or more electronic tools for students (e.g., users that use the system to obtain knowledge or otherwise receive training) and teachers (e.g., users that use the system to provide knowledge or otherwise train other users) to interact with one another and with course content. The course content may include, for example, live-stream media (e.g., video, audio, etc.) of a lesson, archived media of a lesson, coursework, assignments, presentations, and/or other content that may be presented during a course.

In some implementations, the system may conduct online group learning courses that are integrated with physical learning courses at a physical learning node, such as a university campus, military base, corporate campus, and/or other location.

The system may group students into one or more groups based on information known about each student. During a course session, the system may monitor user interactions made via the electronic tools, and dynamically regroup the students based on the monitored user interactions. Such monitoring, grouping and dynamic regrouping may be performed as disclosed in U.S. patent application Ser. No. 15/265,579, filed Sep. 14, 2016, entitled “NETWORKED ACTIVITY MONITORING VIA ELECTRONIC TOOLS IN AN ONLINE GROUP LEARNING COURSE AND REGROUPING STUDENTS DURING THE COURSE BASED ON THE MONITORED ACTIVITY,” and U.S. patent application Ser. No. 14/658,997, filed Mar. 16, 2015, entitled “SYSTEM AND METHOD FOR PROVIDING GROUP LEARNING VIA COMPUTERIZED STUDENT GROUP ASSIGNMENTS CONDUCTED BASED ON STUDENT ATTRIBUTES AND STUDENT-VARIABLE-RELATED CRITERIA,” which issued as U.S. Pat. No. 9,691,291 on Jun. 27, 2017, the contents of each of which are hereby incorporated by reference in their entireties herein.

In some implementations, the system may monitor user interactions and may generate and/or update user profiles of users based on the monitored user interactions. Each user profile may include, among other information, competency scores of a user. A competency score may reflect a level or knowledge, ability or achievement with respect to a category of information or skill. For example, a competency score for communication skills may reflect a communication ability of a user. A competency score for a particular subject matter may reflect a user's knowledge of that subject matter. The user profile may include information known about the user other than competency scores. For instance, the user profile may include an information indicating an education level, professional certifications, and/or other information known about the user that is not a competency score.

The user profile may be used in various ways, such as for the aforementioned grouping/regrouping, but also for workforce assignments. For example, the system may assign users (whether students or teachers) to a workforce to complete or otherwise resolve a task, which may be a group learning project or other group project. A workforce may be comprised of one or more users selected to complete the task.

To generate a task, the system may obtain event information that describes various events. Such events may be automatically (e.g., by the system without human intervention) detected via event listeners or monitors or proctors. Examples of automatically detected events include, without limitation, suspected network intrusion events (e.g., a number of failed logon attempts), suspected malicious request events (e.g., a number of requests within an time interval that exceeds an expected number, which may indicate a potential denial of service style attack), and/or other types of automatically detected events. Although the foregoing and other examples throughout this disclosure may refer to cyber related events and tasks, these are merely examples and one of ordinary skill in the art would understand the invention to apply to other types of events and tasks for which workforces may be assigned may be used.

The system may generate a task based on the obtained events. For example, the system may correlate detected events into an actionable item that should be resolved via a task. The system may automatically associate the task with one or more task parameters. A task parameter may describe what is needed to resolve the task. For example, a task related to network intrusion mitigation may require knowledge relating to network authentication systems and an ability to conference with other users to confirm and mitigate a problem. As such, the task may be associated with task parameters that require the foregoing skills. In some instances, a task may be manually input by a user, such as to create a training task, create a cyber objective to be accomplished, and/or achieve some other objective. In these instances, the user may input task parameters relating to the task.

Whether a task is manually or automatically generated, the system may identify a workforce to handle the task. The system may do so by matching task parameters of the task with user profile information such as competency scores to identify a workforce. In some respects, the workforce may be generated in a manner similar to the way in which students are grouped for group learning.

In some implementations, the system may match the task with users based on machine learning models that model outcomes of tasks based on user profiles of users assigned to handle the tasks. For example, a machine learning model may output a predicted outcome score based on task parameter inputs and competency score (and/or other user profile information) inputs. The model may be based on empirical information, training information, and/or other information than can inform the model of potential outcomes. In this sense, a workforce may be “optimal” based on having the highest predicted outcome score.

In some implementations, the system may match the task with users based on one or more rules. For example, a rule may specify that a network intrusion task associated with a first number (or range of number) or first type of intrusion events should be handled by users who have at least a first competency score with respect to authentication systems, while a network intrusion task associated with a second number (or range of number) or second type of intrusion events should be handled by users who have at least a second competency score with respect to authentication systems. In addition, competency scores may be broken down or categorized by type to more finely define and score a user's set of skills and experiences. In this sense, the term “optimal” may refer to the best outcome (e.g., most closely matching the rule) given the pool of users available to be assigned to a workforce.

Once a workforce is assigned to a task, the system may monitor performance of the task (and other ongoing tasks). Based on the monitoring, evolving task, conditions, availability of users that can be assigned to a given workforce, and other factors, the system may rebalance the workforce. The system may change roles or responsibilities assigned to a user associated with the task and workforce. In other words, the system may add a user to, remove a user from, replace one user with another user, or otherwise modify the workforce to address any changing needs of the task and/or changing environment. Further based on the monitoring, each user profile may be updated based on user performance of the task. As such, a user who is underperforming at a given task may be rebalanced to participate in another task (or no task at all).

Having described an overview of various implementations of the invention, attention will now be turned to an exemplary system architecture.

Exemplary System Architecture

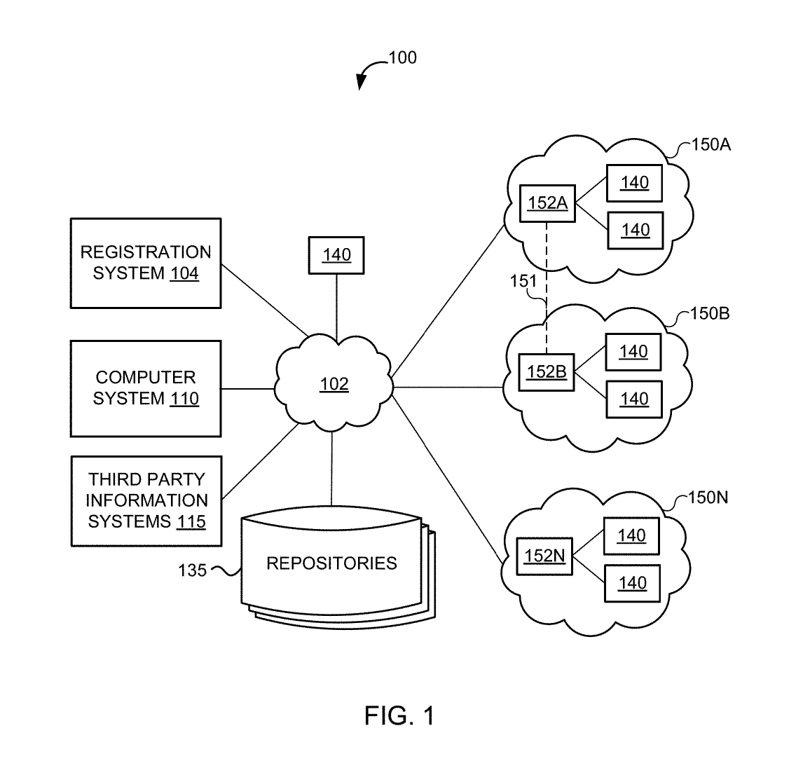

FIG. 1 illustrates a system 100 for optimizing workforces for tasks based on observations of workforce users in an online learning management system integrated with physical learning nodes that can be interconnected with other physical learning nodes for multi-site workforce optimizations, according to an implementation of the invention.

System 100 may include, without limitation, a registration system 104, a computer system 110, third party information systems 115, repositories 135, client devices 140, physical learning nodes 150A-N, and/or other components.

Generally speaking, registration system 104 may obtain, store (using, for example, repositories 135), and provide registration information for students, instructors, physical learning nodes, and/or other entities or components. Once students are registered to take the course (and instructors are registered to instruct at least parts of a course), computer system 110 may generate and provide various electronic tools for conducting and participating in online learning courses. In some implementations, computer system 110 may form initial groups of students registered for a course based on student information known about students. The computer system 110 may monitor the course term, including individual students in their respective groups, and may generate student and instructor profiles that indicate performance of students and instructors during the course term.

The computer system 110 may use the profiles in various ways. For instance, during the course term, computer system 110 may dynamically regroup the students over time based on student profiles so that the composition of student groups are changed during the course term. In the context of workforce distribution, computer system 110 may dynamically assign students (and/or teachers) to a workforce that handles a given task, which may be associated with certain task parameters that define what is needed to resolve the task. For example, a task relating to mitigation of network intrusion may be associated with task parameters that require skills relating to network security and authentication, and requires communication skills with other members of the workforce handling the same task. In this example, computer system 110 may assign users to workforces based on their performance (including knowledge-based performance and social-based performance) during the course term for a course relating to (at least partially or fully) network security and authentication.

In some implementations, computer system 110 may also monitor or receive as input data from monitoring services or otherwise collected data, using techniques similar to monitoring a course term, performance of tasks for which a workforce was assigned. In this manner, workforce user (who may have been a “student” during a prior course term) may be monitored and assessed during performance of a task. The user's profile may be updated to reflect the user's performance during the task. As such, computer system 110 may monitor a user's performance (based on various metrics described herein including incorporated disclosures) during a course term and/or during resolution of a task to generate or update the user's profile.

In some implementations, during the course of completing a task, the workforce may be re-optimized, similar to the manner in which students are regrouped during a course term. In this manner, the computer system may continuously (e.g., periodically at predefined intervals) assess a workforce handling a given task to determine whether the workforce should be changed (e.g., swap one workforce user for another workforce user, add a workforce user, remove a workforce user, etc.).

In some implementations, the computer system 110 may integrate with third party information systems 115. For example, computer system 110 may provide information regarding students (including student performance), teachers (including teacher performance), courses (including subject matter), tasks (including performance during tasks), and/or other information generated or obtained by computer system 110, all of which may be stored in one or more repositories 135. In this manner, computer system 110 may be accessed by third party information systems 115 to obtain information monitored, generated, or otherwise stored by computer system 110.

In some implementations, the computer system 110 may integrate with physical learning nodes 150. A physical learning node 150 set (illustrated in FIG. 1 as nodes 150A, 150B, 150N) may include a physical site or location from which users interact with system 100. Each physical learning node 150 may have computer network 151 (151A, 151B, 151N) that accesses network 102 (e.g., a wide area network such as the Internet) via a network device 152 (152A, 152B, 152N) (e.g., a network switch), which may operate a firewall or other security measure that manages network traffic into and out of the computer network 151.

Examples of physical learning nodes 150 include, without limitation, a university system, a military base or training facility, a corporate campus, and/or other location from which students or teachers may access computer system 110. A given physical learning node 150 may be associated with one or more geographical locations. For example, a university system or military training facility may have multiple locations throughout the country. In these instances, a given physical learning node 150 may be associated with multiple distinct physical locations that its computer network 151 spans. Further in these instances, each distinct physical location may be associated with a sub-net address. In other instances, based on particular needs, each physical location of a military base or training facility, university system, corporate campus, etc., may be associated with its own physical learning node 150.

In some implementations, one physical learning node 150 may be coupled to another physical learning node 150 through an inter-node link 151. For example, one university system may be coupled to another university system through inter-node link 151 (or one location of a university system may be connected to another portion of the university system). An inter-node link 151 may include a Virtual Private Network (VPN) connection, a dedicated hard-link (e.g., a core “backbone” link between two or more sites), and/or other type of communication link that connects two or more sites either via private connection through a wide area network or through a dedicated hard-link between only two or more sites that are part of the hard-link.

In some implementations, computer system 110 may conduct online group learning courses that are integrated with physical learning courses at a physical learning node 150. A physical learning course may include conventional classrooms in which students learn from instructor in person. Such integration permits augmentation of traditional classrooms with electronic group learning, collaboration between different instructors or physical learning nodes, and/or other benefits as will be apparent based on the disclosure herein.

System integration with traditional classrooms (whether at a university, military facility, corporate campus, etc.) may permit an instructor to provide enhanced teaching to a classroom. For example, in a traditional classroom, students may logon using their own client device 140 or a university-provided client device 140 (e.g., that is part of a classroom). Such logon may use the university's computer network 152 (or in other implementations the user's Internet access). Use of the university's computer network 152 may result in automatic authentication of the user, provided that the university's computer network 152 has been registered with the system, and provided that the user's client device 140 is already known to the computer system 110 to be associated with the user. The computer system 110 may provide electronic tools for the instructor and students to interact with one another within a traditional classroom. Furthermore, the instructor may remotely conduct certain courses, or authorize guest speaker/lecturers to remotely logon to give a portion or all of a given course session. Still further, a given student may remotely logon to attend a traditional classroom, which may be live-streamed via computer system 110.

System integration with traditional classrooms (whether at a university, military facility, corporate campus, etc.) may permit collaboration among different physical learning nodes 150. For example, and without limitation, a professor from a first university may be a registered instructor for an online group learning course taken by students from the first university and also students from one or more other universities. Students from the other universities may still attend traditional physical classrooms to participate in the online group learning course, which is taught from the professor from the first university via computer system 110. Alternatively or additionally, students from the first university and/or the other universities may remotely logon (e.g., outside of their university's computer network and not while in a traditional physical classroom) to the computer system 110. In some instances, two or more instructors may co-teach a group learning course via computer system 110, while students may be at physical classrooms to logon and/or may logon remotely.

In another example, one or more users from a first military facility (and/or other military facilities) may provide cyber training to users at the first military facility and/or at other military facilities. Users at the first military facility and/or at other military facilities may logon from their respective facilities and/or remotely to participate in the cyber training.

Registration system 104 may be configured to display course listings, requirements, and/or other course-related information. Registration system 104 may receive registrations of students to courses, including online group learning courses described herein. Upon receipt of a registration, registration system 104 may register a student to take a course. During the registration process, registration system 104 may obtain student information such as, without limitation, a location from which the student accesses the system (e.g., an identification of a physical learning node 150 the student accesses the system), demographic information, gender information, academic records (e.g., grades, etc.), profession information, personal information (e.g., interests/hobbies, favorite cities, vacation spots, languages spoken, etc.), and/or other information about the student. Such student information may be stored in a repository 135.

In some implementations, registration system 104 may register an instructor to provide instructions for a course. For instance, registration system 104 may obtain instructor information such as, without limitation, subject matter expertise, a location from which the instructor teaches (e.g., an identification of a physical learning node 150 from which the instructor normally teaches), demographic information, gender information, academic records (e.g., grades, etc.), profession information, personal information (e.g., interests/hobbies, favorite cities, vacation spots, languages spoken, etc.), and/or other information about the instructor. Such instructor information may be stored in a repository 135.

In some implementations, registration system 104 may register a physical learning node 150 from which students and/or instructors may interact with computer system 110. For example, registration system 104 may obtain node information such as, without limitation, a physical location (e.g., address or geo-location), an electronic location (e.g., an Internet Protocol address for a network switch of a network for the physical learning node 150, subnet addresses for sub-networks of the network for the physical learning node 150, etc.), and/or other information about the physical learning node 150. Such node information may be stored in a repository 135.

Having described a brief overview of an exemplary system architecture, attention will now be turned to particular implementations of generating tasks and identifying workforces for the tasks in an online group learning environment that integrates with physical learning nodes.

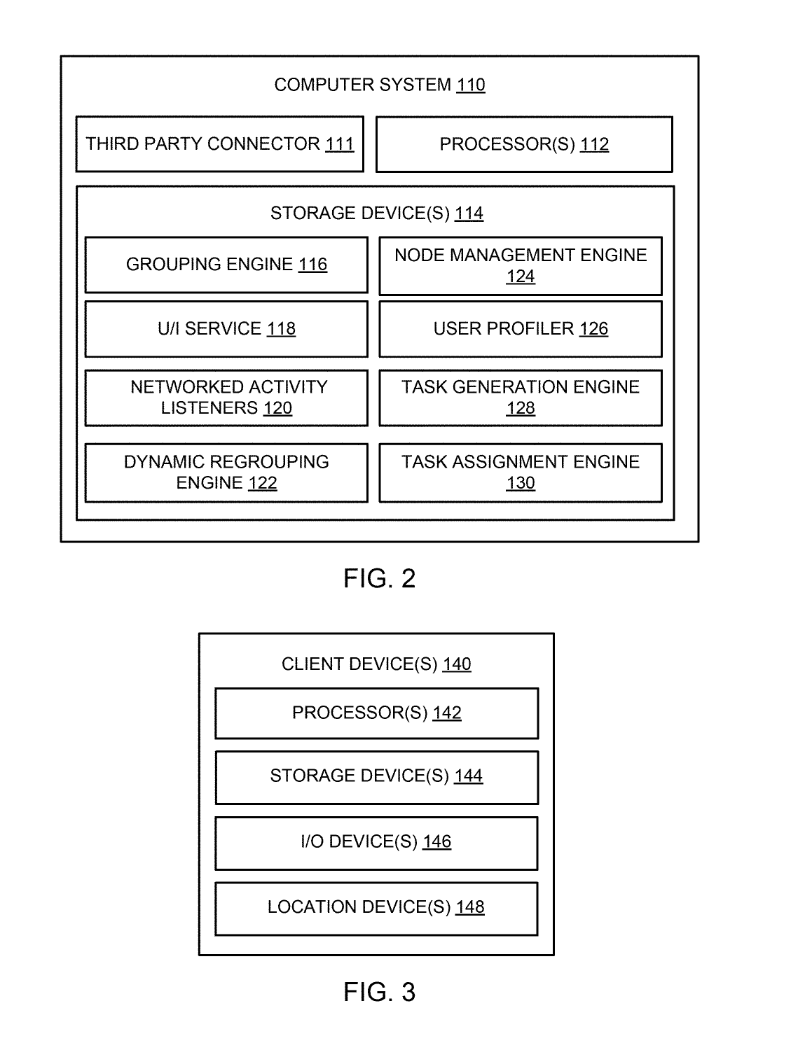

Referring to FIG. 2, computer system 110 may include a third-party connector 111, one or more processors 112 (also interchangeably referred to herein as processors 112, processor(s) 112, or processor 112 for convenience), one or more memory and storage devices 114, and/or other components. Third party connector 111 may permit integration with third party systems such as third-party information systems 115. In some implementations, a third-party connector 111 may include an Application Programming Interface (“API”) that exposes one or more functional calls to obtain information from computer system 110, provide information to computer system 110, or otherwise interact with computer system 110 via network 102 and via layers and interfaces of an associated operating system. The API may be implemented in various languages and protocols according to particular needs. In some implementations, a third-party connector 111 may include an adapter that permits the computer system 110 to communicate with third party systems that do not use the API or otherwise have legacy interfaces.

The one or more storage devices 114 may store various instructions that program processors 112. The various instructions when executed by processors 112 and other components of the computer system 110 provide special purpose operations and may include, without limitation, grouping engine 116, User Interface (“UI”) services 118, networked activity listeners 120 (hereinafter also referred to as “listeners 120” for convenience), a dynamic regrouping engine 122, a node management engine 124, a user profiler 126, a task detection or generation engine 128, a task assignment engine 130, and/or other instructions or operations. As used herein, for convenience, the various instructions will be described as performing an operation, when, in fact, the various instructions program the processors 112 (and therefore computer system 110) to perform the operation. It should be noted that these instructions may be implemented as hardware (e.g., include embedded hardware systems).

In some implementations, grouping engine 116 may include grouping the registered students, or more generally users, into an initial set of student groups, or more generally sets of users or user groups. For example, grouping engine 116 may initially assign registered students into groups based on course parameters and various student characteristics. In an implementation, before the course term starts, an instructor of a course may input values for the course parameters that specify grouping criteria (e.g., group size, characteristics by which to group students, etc.). Some or all course parameters may include default parameter values if not specified by the instructor. The default parameter values may be defined by a system developer or administrator.

In some implementations, UI services 118 may generate an instructor user interface and a student user interface for users to conduct and participate in the online group learning course. For example, in an implementation, UI service 118 may generate and transmit various user interfaces used by users (e.g., instructors, students, etc.) to conduct and participate in the course. UI service 118 may be configured as a web service or other service that can generate and transmit user interfaces via the network 102. The user interfaces may include electronic tools configured to facilitate real-time (e.g., chat) or asynchronous (e.g., electronic mail) communication among the users in a group or class-wide. Such electronic tools may be configured as components of a user interface (e.g., widgets, Adobe® Flash® components, Microsoft® Silverlight™ components, JavaScript components, Java™ components, native user interface components, etc.).

In an implementation, an intended recipient may be optionally input and, when input, may cause the corresponding chat message to include (typically at the beginning of the message) an indicator that identifies the intended recipient (e.g., typically an “@” or other recipient indicator followed by an identifier that identifies the intended recipient). In these implementations, various networked activity listeners 120 may be able to better parse and understand the recipients of each chat message when the intended recipient is input.

In some implementations, dynamic regrouping engine 122 may generate a performance score based on the networked activity. Because student performance and other factors may change over time, after each student is initially grouped by the grouping engine 116, during the course term, dynamic regrouping engine 122 may generate a performance score based on monitored networked activity from the networked activity listeners 120. The performance score may be generated based on a communication score determined from the monitored networked communications, an academic achievement score determined from the aggregated academic achievement information, a social score determined from social information indicating social affinities of students, and/or other information. In an implementation, regrouping engine 122 may scale each of the communication score, academic achievement score, and social score when two or more of these scores are combined to generate the performance score for a student. Such scaling may be based on weights assigned to each score and such weights may be based on the course parameters.

In some implementations, node management engine 124, may manage physical location nodes, including authentication related to such nodes, and collaboration between nodes. For example, node management engine 124 may obtain network address information of a given physical location node 150, and may authenticate a client device 140 (whose identity has also been previously registered with the system) that is attempting to access computer system 110 from a network of the physical location node 150. Alternatively or additionally, a given client device 140 separately connects to computer system 110 from outside a given physical location node 150.

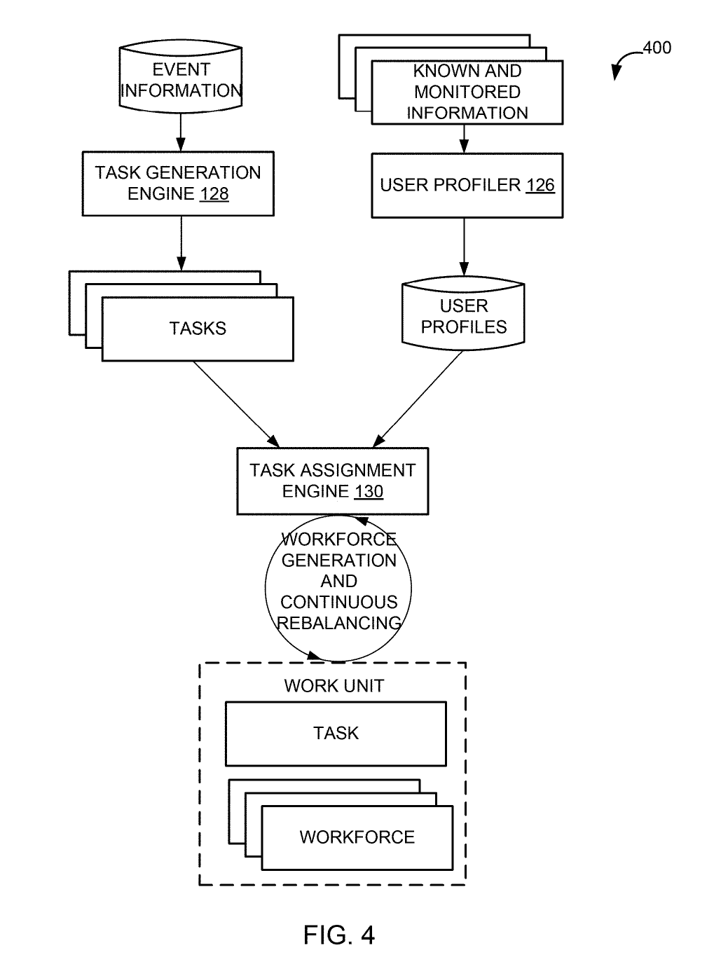

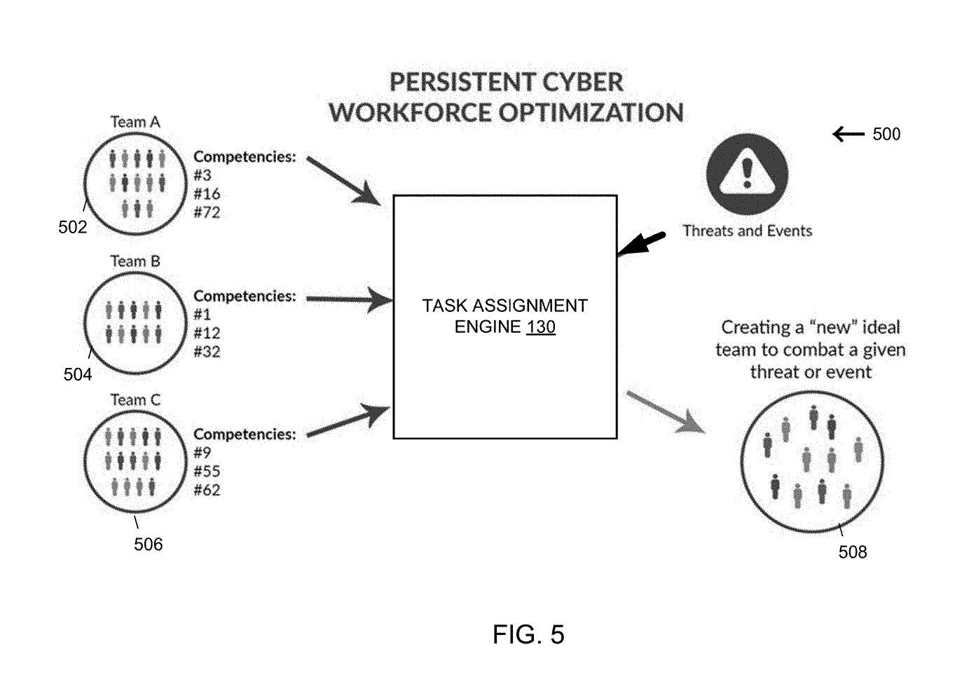

The following description relating to user profiler 126, task generation engine 128, and task assignment engine 130 may refer to the data flow 400 illustrated in FIG. 4 and the exemplary operation scheme illustrated in FIG. 5. Although the exemplary operation of the invention may be described herein as involving separate dynamic regrouping engine 122, the operation of regrouping and rebalancing workforces may be handled by operation of the ask assignment engine 130. The invention is not limited to the particular use of components as named but rather the provision of the operations described.

In some implementations, user profiler 126 may obtain known and monitored information about a user to generate and update a user profile of the user. For example, the user profile may be based on registration information, observed information from online classes such as user interactions, observed information from task participation, and or other source of user information. A given user profile may refer to a student, a teacher, and/or other users who use the system.

Each user profile may include, among other information, a set of attributes which may include competency scores of a user. The user profile may be represented as a silhouette or the set of attributes of the user. The silhouette may represent an abstraction or outline of the competencies, skills, and abilities of a particular user. The silhouette may be a selection of key or representative attributes or scores or may be a representation of the entire set of attributes or scores attributed or associated with a user. A competency score may reflect a level or knowledge, ability or achievement with respect to a category of information or skill. For example, a competency score for communication skills may reflect a communication ability of a user. A competency score for a particular subject matter may reflect a user's knowledge of that subject matter. The user profile may include information known about the user other than competency scores. For instance, the user profile may include an information or attributes for a user indicating an education level, professional certifications, and/or other information known about the user that is not a competency score. This other information, along with the competency score and any other associated information in the user profile, may be used to generate or derive a user silhouette for a particular user.

In some implementations, task detection engine 128 (also shown as Task Generation Engine 128 in FIGS. 2 and 4) may obtain event information that indicates events. Such events may be obtained live from event listeners such as network event listeners (not illustrated), an event log generated by the network event listeners, and/or other source of event information.

Examples of automatically detected events include, without limitation, suspected network intrusion events (e.g., a number of failed logon attempts), suspected malicious request events (e.g., a number of requests within an time interval that exceeds an expected number, which may indicate a potential denial of service style attack), and/or other types of automatically detected events. Although the foregoing and other examples throughout this disclosure may refer to cyber related events and tasks, other types of events and tasks for which workforces may be assigned may be used.

Task detection engine 128, also referenced as task generation engine, may generate a task based on the obtained events. For example, task detection engine 128 may correlate detected events into an actionable item that should be resolved via a task. The system may automatically associate the task with one or more task parameters. A task parameter may describe what is needed to resolve the task. For example, a task related to network intrusion mitigation may require knowledge relating to network authentication systems and an ability to conference with other users to confirm and mitigate a problem. As such, the task may be associated with task parameters that require the foregoing skills. In some instances, a task may be manually input by a user, such as to create a training task, create a cyber objective to be accomplished, and/or achieve some other objective. In these instances, the user may input task parameters relating to the task.

In some implementations, task assignment engine 130 may generate a work unit comprising a task to be completed and a workforce to complete the task. For example, task assignment engine 130 may match task parameters of the task with user profile information such as competency scores to identify a workforce. In some respects, the workforce may be generated in a manner similar to the way in which students are grouped for group learning. For example, each competency score of a user profile may be ranked with respect to competency scores of other user profiles. Such ranking may be used to identify initial workforce assignments and rebalance workforces similar to the way in which ranked user scores are used to group and regroup users, as disclosed in U.S. patent application Ser. Nos. 14/658,997 and 15/265,579 (which were incorporated by reference herein in their entireties).

In some implementations, task assignment engine 130 may match the task with users based on machine-learning based models that model outcomes of tasks based on user profiles of users assigned to handle the tasks. For example, task assignment engine 130 may use a machine learning model to output a predicted outcome score based on task parameter inputs and competency score (and/or other user profile information) inputs. The model may be based on empirical information, training information, and/or other information than can inform the model of potential outcomes. In this sense, a workforce may be “optimal” based on having the highest predicted outcome score.

In some implementations, task assignment engine 130 may match the task with users based on one or more rules. For example, a rule may specify that a network intrusion task associated with a first number (or range of number) of intrusion events should be handled by users who have at least a first competency score with respect to authentication systems, while a network intrusion task associated with a second number (or range of number) of intrusion events should be handled by users who have at least a second competency score with respect to authentication systems. In this sense, the term “optimal” may refer to the best outcome (e.g., most closely matching the rule) given the pool of users available to be assigned to a workforce.

Once a workforce is assigned to a task, task assignment engine 130 may monitor performance of the task (and other ongoing tasks). Based on the monitoring, evolving task, conditions, availability of users that can be assigned to a given workforce, and other factors, the system may rebalance the workforce. In other words, task assignment engine 130 may add a user to, remove a user from, replace one user with another user, or otherwise modify the workforce to address any changing needs of the task and/or changing environment. Further based on the monitoring, each user profile may be updated based on user performance of the task. As such, a user who is underperforming at a given task may be rebalanced to participate in another task (or no task at all).

Typically, though not necessarily, multiple tasks will be concurrently operating during a given time. As such, in some implementations, task assignment engine 130 may optimize distribution of workforce across all tasks (i.e., obtain the overall best outcome scores given the available pool of users even if a given task does not receive the highest outcome score it could have otherwise achieved). As shown in FIG. 4, tasks and workforces may be organized as “work units” and may be subject to continuous rebalancing.

In some implementations, a task may be associated (either automatically by task generation engine 128 and/or after task generation such as by a user) with a priority or “threat” level. Task assignment engine 130 may prioritize workforce assignments based on the priority level.

In some implementations, as the population of users (workers) become available, workforces can be rebalanced. Rebalancing of workforces may be handled by either of a combination of task assignment engine 130 and/or dynamic regrouping engine 122. For example, some workers may finish existing tasks and be made available. In other instances, a user may be pulled off an existing task to be automatically rebalanced into a new task (with another user replacing that user—or the moved user is not replaced). As shown in FIG. 4, a user profiler 126 may continuously update the database of user profiles to reflect additional and changing data—including data that affects user competency scores. As the user profiles and competency scores change over time, the task assignment engine 130 may rebalance the workforce.

In some implementations, a given user may be marked as unavailable. For example, the user profile may be stored in association with a flag indicating such unavailability. A user may be flagged as unavailable because the user is working on a priority task, is out sick, or is otherwise unavailable to be put into a workforce. In these instances, a user marked as unavailable may not be selected for task assignment or rebalancing.

As shown in FIG. 5, a workforce optimization process 500 may start with detection of a particular threat or event, which may lead to an input to the task assignment engine 130. The task assignment engine automatically surveys workforces or teams previously established, e.g., Team a 502, Team B 504 and Team C 506, as well as available users that may or may not be assigned to other workforces or teams of users. Based upon considerations of the priority level of the newly detected threat in comparison to priorities of other tasks and the competencies and/or related scores of available users, task assignment engine 130 may generate a new optimal or “ideal” team or workforce 508 to combat the new or growing threat as detected. To the extent task assignment engine 130 pulls users from one or more of workforce teams 502-506 for inclusion in team 508, it may rebalance those teams and also add team members as part of the rebalancing. For example, if task assignment engine 130 pulls a team member X from Team A 502 having a certain competency based on that user's profile, then it may also add an available member Y to Team A 502 to help rebalance that workforce and offset for the removal of team member X. In addition, team members may be assigned to multiple workforces and the process of determining which users or team members to assign to a new workforce, e.g., team 508, the task assignment engine 130 may consider the number of workforces and/or level of commitment of users to other tasks and workforces.

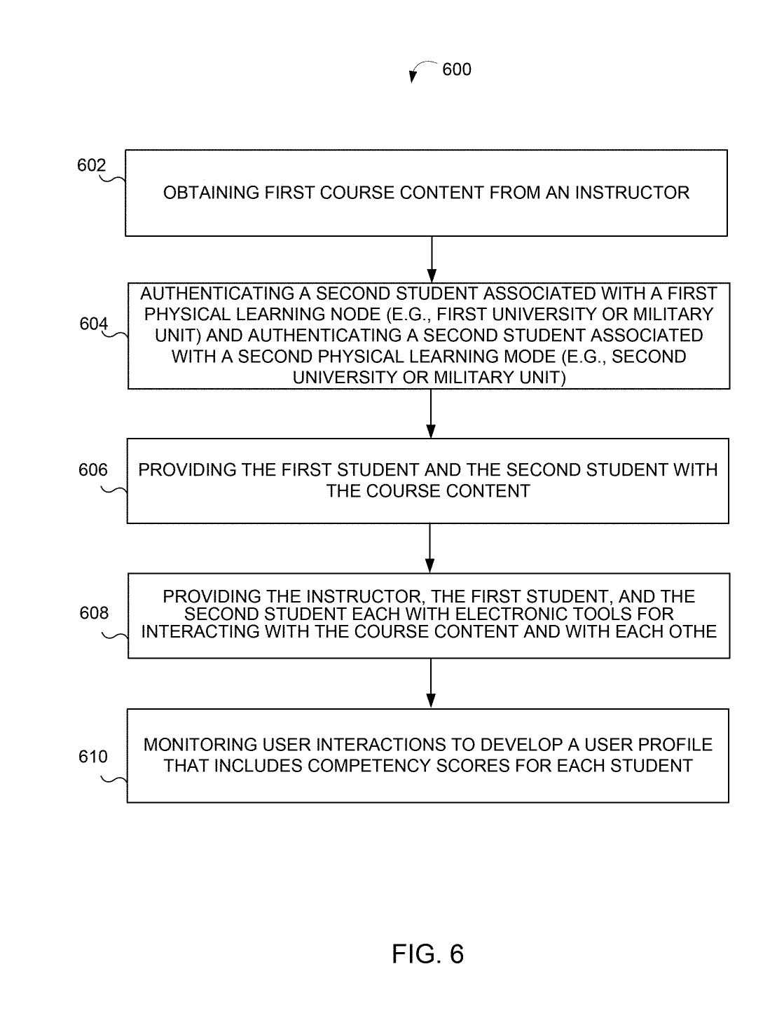

FIG. 6 illustrates an exemplary process 600 of integrating an online learning management system with physical learning nodes that can be interconnected with other physical learning nodes, according to an implementation of the invention.

In an operation 602, process 600 may include obtaining first content from an instructor. The instructor may be associated with a physical learning node 150 such as a university, military unit, corporation, etc.

In an operation 604, process 600 may include authenticating a first student associated with a first physical learning node and a second student associated with a second physical learning node. For example, the first student may be logging onto computer system 110 via an electronic interface provided by computer system 110. The first student may be physically onsite at the first physical learning node (such as the first student's university campus, military base, corporate office, etc.). The computer system 110 may recognize the network address and/or identity of a client device 140 being used by the first student and may authenticate the first student and recognize that the first student is associated with the first physical learning node. Furthermore, the computer system may recognize that the first physical learning node is collaborating with the second physical learning node, as well as with the physical learning node associated with the instructor to allow participation in cross-site online group learning. Alternatively, the client device 140 being used by the first student may be offsite from the first physical learning node, in which case the computer system 110 may recognize that the first student is a member (e.g., student, soldier, employee, etc.) of the first physical learning node based on credential information provided by the first student. The second student may similarly be authenticated and identified in any manner similar to that described above with respect to the first student.

In an operation 606, process 600 may include providing the first student and the second student with the course content. The course content may include a live-stream or asynchronous (not live) stream of media. Alternatively or additionally, the course content may include documents or other files available for download or streaming.

In an operation 608, process 600 may include providing the instructor, the first student, and the second student each with respective electronic tools for interacting with the course content and/or each other (subject to any group limitations described herein—through incorporated content or otherwise).

In an operation 610, process 600 may include monitoring user interactions to develop a user profile that includes competency scores for each user. For example, process 600 may monitor user interactions via the electronic tools to generate and/or update user profiles.

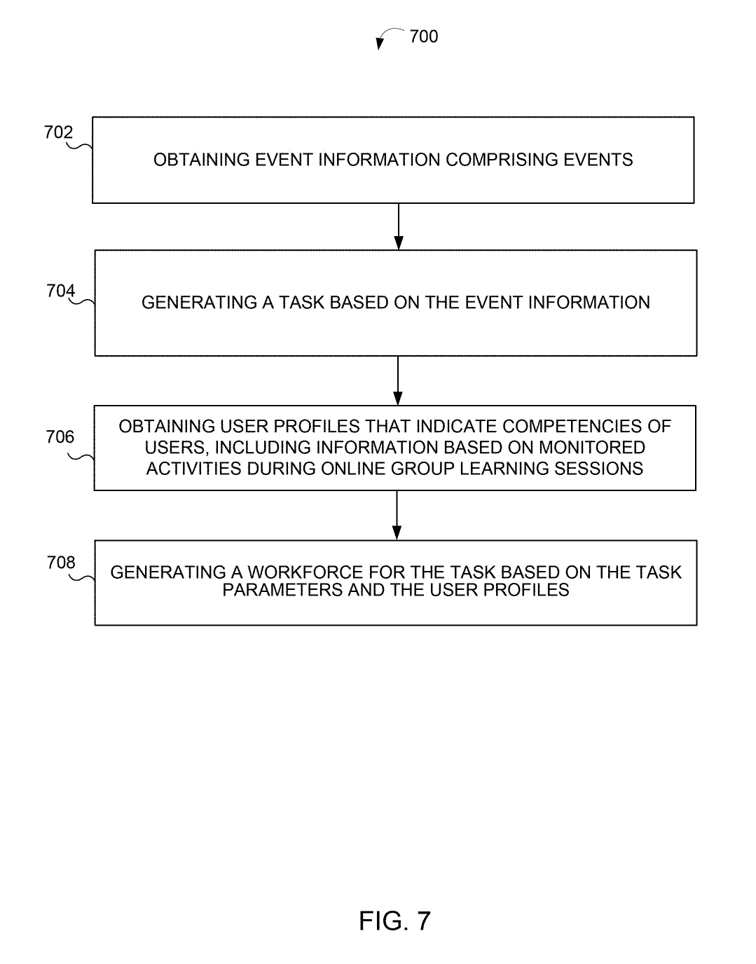

FIG. 7 illustrates a process 700 of optimizing workforces for tasks based on observations of the users in an online learning management system integrated with physical learning nodes that can be interconnected with other physical learning nodes for multi-site workforce optimizations, according to an implementation of the invention.

In an operation 702, process 700 may include obtaining event information that specify events. Such events may be automatically (e.g., by the system without human intervention) detected via event listeners.

In an operation 704, process 700 may include generating a task based on the event information. In some implementations, a task may be generated based on manually input information from a user.

In an operation 706, process 700 may include obtaining user profiles that indicate competencies of users, including information based on monitored activities during online group learning sessions and/or participation in task resolution.

In an operation 708, process 700 may include generating a work unit that identifies a workforce for completing the task based on the task (and its task parameters) and user profile.

Computer system 110 may be configured as a server (e.g., having one or more server blades, processors, etc.), a desktop computer, a laptop computer, a smartphone, a tablet computing device, and/or other device that is programmed to perform the functions of the computer system as described herein.

Referring to FIG. 4, client device 140 may be configured as a personal computer (e.g., a desktop computer, a laptop computer, etc.), a smartphone, a tablet computing device, and/or other device that can be programmed to participate in a grouped online course. Client device 140 may include one or more physical processors 142 programmed by computer program instructions stored at storage devices 144. A client device 140 may include one or more input/output (“I/O”) devices 146, one or more location devices 148 (e.g., a Global Positioning System receiver that receives coordinates from satellites or other above-head devices), and/or other types of devices. The location devices 148 may provide location information that indicates a location of the client device 140 to computer system 110. Such location information may be used by the computer system to group and/or regroup students.

Although illustrated in FIG. 1 as a single component, computer system 110 and client device 140 may each include a plurality of individual components (e.g., computer devices) each programmed with at least some of the functions described herein. In this manner, some components of computer system 110 and/or end user device 140 may perform some functions while other components may perform other functions, as would be appreciated. The one or more processors 112 may each include one or more physical processors that are programmed by computer program instructions. The various instructions described herein are exemplary only. Other configurations and numbers of instructions may be used, so long as the processor(s) 112 are programmed to perform the functions described herein.

Furthermore, it should be appreciated that although the various instructions are illustrated in FIG. 1 as being co-located within a single processing unit, in implementations in which processor(s) 112 includes multiple processing units, one or more instructions may be executed remotely from the other instructions.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the instructions.

The various instructions described herein may be stored in a storage device 114, which may comprise random access memory (RAM), read only memory (ROM), and/or other memory. The storage device may store the computer program instructions (e.g., the aforementioned instructions) to be executed by processor 112 as well as data that may be manipulated by processor 112. The storage device may comprise floppy disks, hard disks, optical disks, tapes, or other storage media for storing computer-executable instructions and/or data.

The repositories 135 and other databases described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. In addition, the system may include or access graph databases, e.g., Resource Description Framework (RDF) database adapted to store user profile and/or task, threat and workforce data in a RDF triple format and may be used to populate a graph database for use in presenting graphical interfaces comprising nodes and edges showing relatedness of threats, tasks, workforces, users and other items of interest. The database may comprise one or more such databases that reside in one or more physical devices and in one or more physical locations. The database may store a plurality of types of data and/or files and associated data or file descriptions, administrative information, or any other data.

The various components illustrated in FIG. 1 may be coupled to at least one other component via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing Figures, different numbers of entities than those depicted may be used. Furthermore, according to various implementations, the components described herein may be implemented in hardware and/or software that configure hardware.

The described operations of FIG. 6 and other process diagrams may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an illustrative (though non-limiting) operation, for a virtual synchronous classroom of 30 students or less, instructor-to-student interaction (micro-data), peer-to-peer student academic (and social) interactions, and academic achievement information may be tracked and recorded (e.g., by the networked activity listeners 120). The foregoing may be matrixed together on a day-to-day (or session-to-session) basis, or when an output variable is identified, such as student academic interaction with other students within the virtual classroom, student answers an instructor's questions, student doesn't answer other student or instructor's questions over a time stamped period, or results of student assignment, quiz, or test.

The various user interfaces described herein may take the form of web pages, smartphone application displays, MICROSOFT WINDOWS or other operating system interfaces, and/or other types of interfaces that may be rendered by a client device. As such, any appearance or depictions of various types of user interfaces provided herein are illustrative purposes.

Other implementations, uses and advantages of the invention will be apparent to those skilled in the art from consideration of the specification and practice of the invention disclosed herein. As used herein throughout, the term “exemplary” is intended to mean “example of.” The specification should be considered exemplary only, and the scope of the invention is accordingly intended to be limited only by the following claims.

What is claimed is:

1. A system of identifying and rebalancing a workforce of users from within a pool of users for resolution of a task based on user attributes that indicate user competencies, skills, and abilities, the system comprising:
a computer system comprising one or more physical processors programmed by computer program instructions that, when executed, cause the computer system to:
obtain event information comprising an indication of events;
generate a task based on the event information, wherein the task is associated with at least a first task parameter that specifies a requirement of the task;
obtain a plurality of user profiles comprising at least a first user profile of a first user, the first user profile comprising a set of first user attributes, the set of first user attributes comprising a first competency score of the first user, wherein the first competency score reflects a level of skill or knowledge of the first user; and
generate, at a first time, a workforce comprising a set of users and including the first user, based on the first task parameter and the set of first user attributes.

2. The system of claim 1, wherein the computer system is further caused to:
generate and provide one or more electronic tools for the first user to participate in an online group learning course;
monitor one or more user interactions, relevant to the first user, associated with the online group learning course;
generate the first competency score of the first user based on the one or more user interactions; and
add the first competency score to the first user profile.

3. The system of claim 1, wherein the computer system is further caused to:
determine, at a second time after the first time, that the task has changed; and
rebalance, at the second time, the set of users assigned to the workforce based on one or both of: 1) a determination that the task has changed; and 2) a determination of a change to one or more user competency scores assigned to or available to be assigned to the workforce.

4. The system of claim 3, wherein the computer system is caused to rebalance the workforce by one or both of: 1) adding and/or removing one or more users to/from the workforce; and 2) altering task assignments of one or more users in the workforce.

5. The system of claim 3, wherein the determination that the first task has changed is based on a determined change in the first task parameter that specifies the requirement of the task.

6. The system of claim 1, wherein the computer system is further caused to:
determine, at a second time after the first time, that the first competency score has changed; and
rebalance, at the second time, the workforce based on the determination that the first competency score has changed.

7. The system of claim 6, wherein the determination that the first competency score has changed is based on a determined change in the level of skill or knowledge of the first user.

8. The system of claim 1, wherein to generate the computer system is further caused to correlate the events into an actionable item that is to be resolved by the task.

9. The system of claim 1, wherein the set of first user attributes further comprises one or more of a performance score, a communication score, an academic achievement score, a social score, an education level, and a set of professional certifications.

10. A system of identifying and rebalancing a workforce of users from within a pool of users for resolution of a task based on user attributes that indicate user competencies, skills, and abilities, the system comprising:
a computer system comprising one or more physical processors programmed by computer program instructions stored in an associated memory for execution by the processors;
a task detection engine configured to obtain event information comprising an indication of events, and generate a task based on the event information, wherein the task is associated with at least a first task parameter that specifies a requirement of the task;
a task assignment engine configured to obtain a plurality of user profiles comprising at least a first user profile of a first user, the first user profile comprising a set of first user attributes, the set of first user attributes comprising a first competency score of the first user, wherein the first competency score reflects a level of skill or knowledge of the first user;
wherein the task assignment engine is further configured to generate, at a first time, a workforce comprising a set of users including the first user, based on the first task parameter and the first user profile; and
a dynamic regrouping engine configured to rebalance, at a second time after the first time, the workforce set of users based on one or both of: 1) a detected change in the first task parameter; and 2) a detected change to one or more user competency scores assigned to or available to be assigned to the workforce.

11. The system of claim 10, wherein the task assignment engine is further configured to:
generate and provide one or more electronic tools for the first user to participate in an online group learning course;
monitor one or more user interactions, relevant to the first user, associated with the online group learning course;
generate the first competency score of the first user based on the one or more user interactions; and
add the first competency score to the first user profile.

12. The system of claim 10, wherein the set of first user attributes further comprises one or more of a performance score, a communication score, an academic achievement score, a social score, an education level, and a set of professional certifications.

13. A system for integrating an online learning management system with physical learning nodes, the system comprising:
a computer system comprising one or more physical processors programmed by computer program instructions that, when executed, cause the computer system to:
obtain first content from an instructor;
authenticate a first student associated with a first physical learning node and a second student associated with a second physical learning node;
provide the first student and the second student with the course content;
provide the instructor, the first student, and the second student each with respective electronic tools for interacting with the course content and/or each other;
monitor user interactions via the respective electronic tools; and
generate a set of user profiles each of which includes a set of user attributes including a set of competency scores associated with at least the first student and the second student.

14. The system of claim 13, wherein the set of user attributes further comprises one or more of a performance score, a communication score, an academic achievement score, a social score, an education level, and a set of professional certifications.
